(19) United States
(12) Patent Application Publication
(10) Pub. No.: US 2009/0105432 A1
(43) Pub. Date: Apr. 23, 2009

(54) METHOD FOR POLYMERISING ETHYLENICALLY UNSATURATED POLYISOBUTENE

(75) Inventors: Hans Peter Rath, Grunstadt (DE); Hans-Michael Walter, Freinsheim (DE); Oskar Nuyken, Munchen (DE); Fritz Elmar Kuehn, Nandlstadt (DE); Yanmei Zhang, Muenchen (DE); Hui Yee Yeong, Perak (MY)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/063,298

(22) PCT Filed: Aug. 11, 2006
(86) PCT No.: PCT/EP06/65269

§ 371 Date: Feb. 8, 2008

(30) Foreign Application Priority Data
Aug. 12, 2005 (DE) 10 2005 038 281.9

(51) Int. Cl. C08F 4/20; C08F 4/80; C08F 4/12; C07F 5/02; C07F 9/70; C07F 15/04; C07F 1/08; C07F 9/90; C07F 5/06; C08F 4/44

(52) U.S. Cl. 526/120; 526/171; 526/170; 526/134; 526/131; 556/27; 556/7; 556/30; 556/31; 556/28; 556/112; 556/141; 556/140

(57) ABSTRACT

The invention relates to a method for polymerising ethylenically unsaturated monomers, wherein ethylenically unsaturated monomers are polymerised in the presence of a solvent-stable transition metal complex having slightly co-ordinating anions as polymer catalysts. The invention also relates to specific solvent-stable transition metal complexes having slightly co-ordinating anions. The invention also relates to highly reactive copolymers which are made of monomers comprising isobutene and at least one vinylaromatic compound which can be obtained according to said inventive method.

The present invention relates to a process for polymerizing ethylenically unsaturated monomers and especially for preparing highly reactive isobutene homo- or copolymers, in which ethylenically unsaturated monomers, for example isobutene or an isobutenic monomer mixture, are polymerized in the presence of a solvent-stabilized transition metal complex with weakly coordinating anions as polymerization catalyst. The invention further relates to certain solvent-stabilized transition metal complexes with weakly coordinating anions. The invention also provides copolymers which are formed from monomers comprising isobutene and at least one vinylaromatic compound, which are obtainable by the process according to the invention.

Highly reactive polyisobutene homo- or copolymers are understood to mean, in contrast to the so-called low-reactivity polymers, those polyisobutenes which comprise a high content of terminal ethylenic double bonds. In the context of the present invention, highly reactive polyisobutenes shall be understood to mean those polyisobutenes which have a content of vinylidene double bonds (α-double bonds) of at least 60 mol %, preferably of at least 70 mol % and in particular of at least 80 mol %, based on the polyisobutene macromolecules. In the context of the present invention, vinylidene groups are understood to mean those double bonds whose position in the polyisobutene macromolecule is described by the general formula

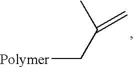

i.e. the double bond is in the α-position in the polymer chain. “Polymer” represents the polyisobutene radical shortened by one isobutene unit. The vinylidene groups exhibit the highest reactivity, whereas a double bond lying further toward the center of the macromolecules exhibits no or in any case lower reactivity in functionalization reactions. Highly reactive polyisobutenes are used, inter alia, as intermediates for producing additives for lubricants and fuels, as described, for example, in DE-A 2702604.

Such highly reactive polyisobutenes are obtainable, for example, by the process of DE-A 2702604 by cationic polymerization of isobutene in liquid phase in the presence of boron trifluoride as a catalyst. A disadvantage here is that the resulting polyisobutenes have a relatively high polydispersity. The polydispersity is a measure of the molecular weight distribution of the resulting polymer chains and corresponds to the quotient of weight-average molecular weight M_{w} and number-average molecular weight Mₙ (PDI=M_{w}/Mₙ).

Polyisobutenes having a similarly high content of terminal double bonds, but having a narrower molecular weight distribution, are obtainable, for example, by the processes of EP-A 145235, U.S. Pat. No. 5,408,018 and WO 99/64482, the polymerization being effected in the presence of a deactivated catalyst, for example of a complex of boron trifluoride, alcohols and/or ethers. A disadvantage here is that it is necessary to work at temperatures distinctly below 0° C. in order actually to obtain highly reactive polyisobutenes.

Highly reactive polyisobutenes are also obtainable by living cationic polymerization of isobutene and subsequent dehydrohalogenation of the resulting polymerization product, for example by the process from U.S. Pat. No. 5,340,881. Here too, it is necessary to work at low temperatures to prepare highly reactive polyisobutenes.

EP-A 1344785 describes a process for preparing highly reactive polyisobutenes using a solvent-stabilized transition metal complex with weakly coordinating anions as a polymerization catalyst. Suitable metals generally mentioned are those of groups 3 to 12 of the Periodic Table; however, only manganese is used in the examples. Although it is possible to polymerize at reaction temperatures above 0° C. in this process, a disadvantage is that the polymerization times are unacceptably long, so that economic utilization of this process becomes unattractive.

It was therefore an object of the present invention firstly to provide a process for preparing highly reactive polyisobutene homo- or copolymers, especially for preparing polyisobutene polymers having a content of terminal vinylidene double bonds of at least 70 mol %, especially of at least 80 mol %, which firstly allows polymerization of isobutene or isobutenic monomer sources at least 0° C., but simultaneously enables distinctly shorter polymerization times. The process should additionally also be advantageously applicable to the polymerization of other monomers.

The object has been achieved by a process for polymerizing ethylenically unsaturated monomers, which comprises polymerizing the ethylenically unsaturated monomers in the presence of a catalyst of the formula I

[M(L)a]^{m+}m(A⁻) (I)

in which
M is Cu (copper), Fe (iron), Mo (molybdenum) or Co (cobalt);
L is a solvent molecule;
A⁻is a weakly coordinating or noncoordinating anion;
a is an integer from 4 to 6; and
m is 1, 2 or 3.

The remarks which follow regarding suitable and preferred embodiments of the subject matter of the invention, especially regarding the monomers and catalysts used in the process according to the invention, regarding the reaction conditions and regarding the polymers thus obtainable apply both taken alone and especially in combination with one another.

In the context of the present invention, isobutene homopolymers are understood to mean those polymers which, based on the polymer, are formed from isobutene to an extent of at least 98 mol %, preferably to an extent of at least 99 mol %. Accordingly, isobutene copolymers are understood to mean those polymers which comprise more than 2 mol % of monomers other than isobutene in copolymerized form.

In the context of the present invention, the following definitions apply to generically defined radicals:

C₁-C₄-Alkyl is a linear or branched alkyl radical having from 1 to 4 carbon atoms. Examples thereof are methyl, ethyl, n-propyl, isopropyl, n-butyl, 2-butyl, isobutyl or tert-butyl. C₁-C₂-Alkyl is methyl or ethyl; C₁-C₃-alkyl is additionally n-propyl or isopropyl.

C₁-C₈-Alkyl is a linear or branched alkyl radical having from 1 to 8 carbon atoms. Examples thereof are the abovementioned C₁-C₄-alkyl radicals and additionally pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, heptyl, octyl and their constitutional isomers such as 2-ethylhexyl.

C₁-C₄-Haloalkyl is a linear or branched alkyl radical which has from 1 to 4 carbon atoms and is substituted by at least one halogen radical. Examples thereof are CH₂F, CHF₂, CF₃, CH₂Cl, CHCl₂, CCl₃, CH₂FCH₂, CHF₂CH₂, CF₃CH₂ and the like.

In the context of the present invention, aryl is optionally substituted phenyl, optionally substituted naphthyl, optionally substituted anthracenyl or optionally substituted phenanthrenyl. The aryl radicals may bear from 1 to 5 substituents which are, for example, selected from hydroxyl, C₁-C₈-alkyl, C₁-C₈-haloalkyl, halogen, NO₂ or phenyl. Examples of aryl are phenyl, naphthyl, biphenyl, anthracenyl, phenanthrenyl, tolyl, nitrophenyl, hydroxyphenyl, chlorophenyl, dichlorophenyl, pentafluorophenyl, pentachlorophenyl, (trifluoromethyl)phenyl, bis(trifluoromethyl)phenyl, (trichloro)methylphenyl, bis(trichloromethyl)phenyl and hydroxynaphthyl.

C₁-C₄-Carboxylic acids represent aliphatic carboxylic acids having from 1 to 4 carbon atoms. Examples thereof are formic acid, acetic acid, propionic acid, butyric acid and isobutyric acid.

C₁-C₄-Alcohol represents a C₁-C₄-alkyl radical as defined above, in which at least one hydrogen atom has been replaced by a hydroxyl group. It preferably represents a monohydric alcohol, i.e. a C₁-C₄-alkyl group in which one hydrogen atom has been replaced by a hydroxyl group. Examples thereof are methanol, ethanol, propanol, iso-propanol, n-butanol, sec-butanol, isobutanol and tert-butanol.

In the context of the present invention, halogen is fluorine, chlorine, bromine or iodine.

In the context of the present invention, vinylaromatic compounds are styrene and styrene derivatives such as α-methylstyrene, C₁-C₄-alkylstyrenes, such as 2-, 3- or 4-methylstyrene and 4-tert-butylstyrene, and halostyrenes such as 2-, 3- or 4-chlorostyrene. Preferred vinylaromatic compounds are styrene and 4-methylstyrene and also mixtures thereof, particular preference being given to styrene.

In the catalyst of the formula I, M is preferably copper, iron or cobalt. M is more preferably copper or iron.

M has an oxidation number of preferably II or III and more preferably of II.

L is a solvent molecule which can bind coordinatively. These are molecules which are typically used as a solvent but simultaneously have at least one dative moiety, for example a free electron pair which can enter into a coordinative bond to the central metal. Examples thereof are nitriles such as acetonitrile, propionitrile and benzonitrile, open-chain and cyclic ethers such as diethyl ether, dipropyl ether, diisopropyl ether, methyl tert-butyl ether, ethyl tert-butyl ether, tetrahydrofuran and dioxane, carboxylic acids, in particular C₁-C₄-carboxylic acids such as formic acid, acetic acid, propionic acid, butyric acid and isobutyric acid, carboxylic esters, in particular the esters of C₁-C₄-carboxylic acids with C₁-C₄-alcohols, such as ethyl acetate and propyl acetate, and carboxamides, in particular of C₁-C₄-carboxylic acids with di(C₁-C₄-alkyl)amines, such as dimethylformamide.

Preferred solvent molecules are those which firstly bind coordinatively to the central metal but secondly are not strong Lewis bases, so that they can be displaced readily from the coordination sphere of the central metal in the course of the polymerization. The solvent ligands L, which may be the same or different, are preferably selected from nitriles of the formula N═C—R¹ in which R¹ is C₁-C₈-alkyl or aryl, and open-chain and cyclic ethers.

In the nitriles, the R¹ radical is preferably C₁-C₄-alkyl or phenyl. Examples of such nitriles are acetonitrile, propionitrile, butyronitrile, pentylnitrile and benzonitrile. More preferably, R¹ is methyl, ethyl or phenyl, i.e. the nitrile is more preferably selected from acetonitrile, propionitrile and benzonitrile. In particular, R¹ is methyl or phenyl, i.e. the nitrile is in particular acetonitrile or benzonitrile. R¹ is especially methyl, i.e. the nitrile is especially acetonitrile.

Suitable open-chain and cyclic ethers are, for example, diethyl ether, dipropyl ether, diisopropyl ether, methyl tert-butyl ether, ethyl tert-butyl ether, tetrahydrofuran and dioxane, preference being given to diethyl ether and tetrahydrofuran.

More preferably, L is a nitrile of the formula N═C—R¹ in which R¹ is preferably methyl, ethyl or phenyl, more preferably methyl or phenyl and in particular methyl.

L may be the same or different solvent molecules. In compound I, however, all L are preferably the same solvent ligands.

A⁻ is a weakly coordinating or noncoordinating anion. Weakly coordinating or noncoordinating anions are those which do not enter into a coordinative bond with the central atom, and which thus do not have a Lewis-basic moiety. Generally, the weakly coordinating or noncoordinating anions are those whose negative charge is delocalized over a large surface of non-nucleophilic and chemically robust groups. For example, weakly coordinating or noncoordinating anions are mono- or binuclear anions with a Lewis-acidic central atom whose electron deficiency is, however, compensated by the binding of a weakly coordinating substituent.

The weakly coordinating or noncoordinating anion A⁻ is preferably selected from BX₄⁻, B(Ar)₄⁻, bridged anions of the formula [(Ar)₃B-(μ-Y)—B(Ar)₃]⁻, SbX₆⁻, Sb₂X₁₁⁻, AsX₆⁻, As₂X₁₁⁻, ReX₆⁻, Re₂X₁₁⁻, AlX₄⁻, Al₂X₇⁻, OTeX₅⁻, B(OTeX₅)₄⁻, Nb(OTeX₅)₆⁻, [Zn(OTeX₅)₄]₂⁻, OSeX₅⁻, trifluoromethanesulfonate, perchlorate, carborates and carbon cluster anions,

where
Ar is phenyl which may bear from 1 to 5 substituents which are selected from halogen, C₁-C₄-alkyl and C₁-C₄-haloalkyl;
Y is a bridging group; and
X is fluorine or chlorine.

Ar is, for example, phenyl, pentafluorophenyl or bis(trifluoromethyl)phenyl, e.g. 3,5-bis(trifluoromethyl)phenyl. Ar in the anion B(Ar)₄⁻ is preferably a substituted phenyl, more preferably bis(trifluoromethyl)phenyl, e.g. 3,5-bis(trifluoromethyl)phenyl, or in particular pentafluorophenyl. In the bridged anions too, Ar is preferably a substituted phenyl group, more preferably bis(trifluoromethyl)phenyl, e.g. 3,5-bis(trifluoromethyl)-phenyl, or in particular pentafluorophenyl.

The bridging group Y may, for example, be CN, NH₂ or a cyclic bridging unit. Cyclic bridging units are those cycles which are bonded via two Lewis-basic moieties. Examples thereof are saturated or unsaturated heterocycles having at least 2 heteroatoms, preferably having at least 2 nitrogen atoms, such as pyrazolediyl, pyrazolinediyl, pyrazolidinediyl, imidazolediyl, imidazolinediyl, imidazolidinediyl, triazolediyl, triazolinediyl, triazolidinediyl, pyrimidinediyl, pyrazinediyl and pyridazinediyl. Preference is given to aromatic heterocycles. Particularly preferred cyclic bridging units are imidazol-1,3-yl and triazolediyl, e.g. [1,2,4]triazole-2,4-diyl.

Y is preferably selected from cyclic bridging groups, particular preference being given to triazolediyl and in particular imidazol-1,3-yl.

X is preferably fluorine.

In the context of the present invention, carborates are understood to mean the anions of carboranes, i.e. of cage-like boron-carbon compounds, for example the anions of closo-, nido- or arachno-carboranes. Examples thereof are the following closo-carborates: [CB₁₁H₁₂]⁻, [CB₉H₁₀]⁻ and [CB₁₁(CH₃)₁₂]⁻. However, preference is given to those carborates in which some of the hydrogen atoms have been substituted by halogen atoms. Examples thereof are [CB₁₁H₆Cl₆]⁻, [1—H—CB₁₁(CH₃)₅Cl₆]⁻, [CB₁₁H₆F₆]⁻ and [1-H—CB₁₁(CH₃)₅F₆]⁻.

In the context of the present invention, carbon cluster anions are understood to mean the anions of carbon clusters, for example of fullerenes. An example thereof is C₆₀⁻.

The weakly coordinating or noncoordinating anion A⁻ is more preferably selected from BX₄⁻, B(Ar)₄⁻, bridged anions of the formula [(Ar)₃B-(μ-Y)—B(Ar)₃]⁻, SbX₆⁻, Sb₂X₁₁⁻, AsX₆⁻, AS₂X₁₁⁻, ReX₆⁻, Re₂X₁₁⁻, AlX₄⁻, Al₂X₇⁻, OTeX₅⁻, B(OTeX₅)₄⁻, Nb(OTeX₅)₆⁻, [Zn(OTeX₅)₄]₂⁻, OSeX₅⁻, trifluoromethanesulfonate and perchlorate.

More preferred weakly coordinating or noncoordinating anions A⁻ are selected from B(Ar)₄⁻ and bridged anions of the formula [(Ar)₃B-(μ-Y)—B(Ar)₃]⁻. Preference is given to those borates B(Ar)₄⁻ in which Ar is 3,5-bis(trifluoromethyl)phenyl or in particular pentafluorophenyl. Preferred bridged anions are those in which Ar is pentafluorophenyl and Y is an imidazole-1,3 bridge.

a is preferably 6. In this case, the metal complex is preferably octahedral or virtually octahedral.

m is preferably 2.

Processes for preparing solvent-stabilized metal complexes with weakly coordinating or noncoordinating counteranions are known in principle and are described, for example, in W. E. Buschmann, J. S. Miller, Chem. Eur. J. 1998, 4(9), 1731, R. E. LaPointe, G. R. Ruff, K. A. Abboud, J. Klosin, New Family of Weakly Coordinating Anions, J. Am. Chem. Soc. 2000, 122(39), 9560, W. E. Buschmann, J. S. Miller, Inorganic Chemistry 33, 2002, 83, 0. Nuyken, F. E. Kuhn, Angew. Chem. Int. Ed. Engl. 2003, 42, 1307, O. Nuyken, F. E. Kühn, Chem. Eur. J. 2004, 10, 6323 and EP-A-1344785, and also in the literature cited therein, which are hereby fully incorporated by reference. The catalysts of the formula I used in accordance with the invention can be prepared analogously to the processes described there.

For example, the catalyst of the formula I can be prepared, by dissolving a salt of the formula M^{x+}(Cl⁻)ₓ in a solvent which corresponds to the solvent molecule L. To introduce the anion A⁻, this solution is then admixed with a silver salt of the appropriate anion, especially with [Ag(L)₄]⁺(A⁻), preferably at a temperature of from −10° C. to room temperature. The silver chloride which precipitates is removed from the reaction solution, for example by filtration, decanting or centrifugation. Subsequently, the solvent is generally at least partly removed, which can be done, for example, by distillation, especially under reduced pressure. The catalyst I can be isolated by customary processes, for example by removing the solvent to dryness or preferably by crystallization in suitable solvents.

In the process according to the invention, the catalysts of the formula I in relation to the monomers used are used in a molar ratio of from 1:10 to 1:1 000 000, more preferably from 1:5000 to 1:500 000 and in particular from 1:5000 to 1:100 000, for example from 1:10 000 to 1:100 000.

The concentration of the catalysts I used in the reaction mixture is in the range of preferably from 0.01 mmol/l to 5 mmol/l, particularly preferably from 0.01 to 1 mmol/l, more preferably from 0.01 to 0.5 mmol/l and in particular from 0.01 to 0.1 mmol/l.

Useful ethylenically unsaturated monomers are all monomers which are polymerizable under cationic polymerization conditions. Examples thereof are linear alkenes such as ethene, propene, n-butene, n-pentene and n-hexene, alkadienes, such as butadiene and isoprene, isoalkenes such as isobutene, 2-methylbutene-1,2-methylpentene-1,2-methylhexene-1,2-ethylpentene-1,2-ethylhexene-1 and 2-propylheptene-1, cycloalkenes such as cyclopentene and cyclohexene, vinylaromatic compounds such as styrene, α-methylstyrene, 2-, 3- and 4-methylstyrene, 4-tert-butylstyrene and 2-, 3- and 4-chlorostyrene, and olefins which have a silyl group such as 1-trimethoxysilyl-ethene, 1-(trimethoxysilyl)propene, 1-(trimethoxysilyl)-2-methylpropene-2,1-[tri(methoxyethoxy)silyl]ethene, 1-[tri(methoxyethoxy)silyl]-propene, and 1-[tri(methoxyethoxy)silyl]-2-methylpropene-2, and also mixtures of these monomers.

Preferred monomers are isobutene, isobutenic monomer mixtures, styrene, styrenic monomer mixtures, styrene derivatives, especially α-methylstyrene and 4-methyl-styrene, the abovementioned cycloalkenes, the abovementioned alkadienes and mixtures thereof.

Particularly preferred monomers are isobutene, isobutenic monomer mixtures, styrene, styrenic monomer mixtures and mixtures thereof. In particular, the monomers used in the polymerization process according to the invention are isobutene, styrene or mixtures thereof.

When the monomer to be polymerized which is used is isobutene or an isobutenic monomer mixture, suitable isobutene sources are both isobutene itself and isobutenic C₄ hydrocarbon streams, for example C₄ raffinates, C₄ cuts from isobutane dehydrogenation, C₄ cuts from streamcrackers and from FCC crackers (fluid catalyzed cracking), provided that they have been freed substantially from 1,3-butadiene present therein. Suitable C₄ hydrocarbon streams comprise generally less than 500 ppm, preferably less than 200 ppm, of butadiene. The presence of 1-butene and also of cis- and trans-2-butene is substantially uncritical. Typically, the isobutene concentration in the C₄ hydrocarbon streams is in the range from 40 to 60% by weight. The isobutenic monomer mixture may comprise small amounts of contaminants such as water, carboxylic acids or mineral acids, without there being critical losses of yield or selectivity. It is appropriate to prevent enrichment of these impurities by removing such harmful substances from the isobutenic monomer mixture, for example, by adsorption on solid adsorbents such as activated carbon, molecular sieves or ion exchangers.

It is also possible to react monomer mixtures of isobutene or the isobutenic hydrocarbon mixture with olefinically unsaturated monomers which are copolymerizable with isobutene. When monomer mixtures of isobutene with suitable comonomers are to be copolymerized, the monomer mixture comprises preferably at least 5% by weight, more preferably at least 10% by weight and in particular at least 20% by weight of isobutene, and preferably at most 95% by weight, more preferably at most 90% by weight and in particular at most 80% by weight of comonomers.

Useful copolymerizable monomers include vinylaromatics such as styrene and α-methylstyrene, C₁-C₄-alkylstyrenes such as 2-, 3- and 4-methylstyrene and also 4-tert-butylstyrene, isoolefins having from 5 to 10 carbon atoms such as 2-methyl-butene-1,2-methylpentene-1,2-methylhexene-1,2-ethylpentene-1,2-ethylhexene-1 and 2-propylheptene-1. Useful comonomers are also olefins which have a silyl group such as 1-trimethoxysilylethene, 1-(trimethoxysilyl)propene, 1-(trimethoxysilyl)-2-methylpropene-2,1-[tri(methoxyethoxy)silyl]ethene, 1-[tri(methoxyethoxy)silyl]propene and 1-[tri(methoxyethoxy)silyl]-2-methylpropene-2.

When copolymers are to be prepared by the process according to the invention, the process can be configured such that preferentially random polymers or preferentially block copolymers are formed. To prepare block copolymers, it is possible, for example, to feed the different monomers successively to the polymerization reaction, in which case the second comonomer is added especially only after the first comonomer has at least partly already polymerized. In this way, it is possible to obtain diblock copolymers, triblock copolymers and higher block copolymers which, depending on the sequence of monomer addition, have one block of one or another comonomer as the terminal block. In some cases, block copolymers are also formed when all comonomers are fed simultaneously to the polymerization reaction but one polymerizes significantly more rapidly than the other(s). This is the case especially when isobutene and a vinylaromatic compound, especially styrene, are copolymerized in the process according to the invention. This preferably forms block copolymers with a terminal polyisobutene block. This is attributable to the vinylaromatic compound, especially styrene, being polymerized significantly more rapidly than isobutene.

The polymerization can be effected either continuously or batchwise. Continuous processes can be carried out in analogy to known prior art processes for continuously polymerizing isobutene in the presence of Lewis acid catalysts in the liquid phase.

The process according to the invention is suitable both for performance at low temperatures, for example from −78 to 0° C., and at higher temperatures, i.e. at least 0° C., for example from 0 to 100 C. For economic reasons in particular, the polymerization is carried out preferably at least 0° C., for example at from 0 to 100° C., more preferably at from 20 to 60° C., in order to minimize the energy and material consumption which is required for cooling. However, it can be carried out just as efficiently at lower temperatures, for example at from −78 to <0° C., preferably at from −40 to −10° C.

When the polymerization is effected at or above the boiling point of the monomer or monomer mixture to be polymerized, it is preferably carried out in pressure vessels, for example in autoclaves or in pressure reactors.

Preference is given to carrying out the polymerization in the presence of an inert diluent. The inert diluent used should be suitable for reducing the increase, generally occurring during the polymerization reaction, in the viscosity of the reaction solution to such an extent that the removal of the heat of reaction formed can be ensured. Suitable diluents are those solvents or solvent mixtures which are inert toward the reagents used. Suitable diluents are, for example, aliphatic hydrocarbons such as butane, pentane, hexane, heptane, octane and isooctane, cycloaliphatic hydrocarbons such as cyclopentane and cyclohexane, aromatic hydrocarbons such as benzene, toluene and the xylenes, and halogenated hydrocarbons such as methyl chloride, dichloromethane and trichloromethane, and also mixtures of the aforementioned diluents. Preference is given to using at least one halogenated hydrocarbon, if appropriate in a mixture with at least one of the aforementioned aliphatic or aromatic hydrocarbons. In particular, dichloromethane is used. Before they are used, the diluents are preferably freed of impurities such as water, carboxylic acids or mineral acids, for example by adsorption on solid adsorbents such as activated carbon, molecular sieves or ion exchangers.

Preference is given to carrying out the polymerization under substantially aprotic, especially under anhydrous, reaction conditions. Aprotic and anhydrous reaction conditions are understood to mean that the water content (or the content of protic impurities) in the reaction mixture is less than 50 ppm and in particular less than 5 ppm. In general, the feedstocks will be dried physically and/or by chemical measures before they are used. In particular, it has been found to be useful to admix the aliphatic or alicyclic hydrocarbons used as solvents, after customary prepurification and predrying, with an organometallic compound, for example an organolithium, organomagnesium or organoaluminum compound, in an amount which is sufficient to remove the water traces from the solvent. The solvent thus treated is then preferably condensed directly into the reaction vessel. It is also possible to proceed in a similar manner with the monomers to be polymerized, especially with isobutene or with the isobutenic mixtures. Drying with other suitable desiccants such as molecular sieves or predried oxides such as aluminum oxide, silicon dioxide, calcium oxide or barium oxide is also suitable. The halogenated solvents for which drying with metals, such as sodium or potassium, or with metal alkyls is not an opinion are freed of water (traces) with desiccants suitable for this purpose, for example with calcium chloride, phosphorus pentoxide or molecular sieves. It is also possible in a similar manner to dry those feedstocks for which treatment with metal alkyls is likewise not an option, for example vinylaromatic compounds.

The monomer and especially the isobutene or the isobutenic starting material is polymerized spontaneously when the initiator system (i.e. the catalyst I) is mixed with the monomer at the desired reaction temperature. It is possible here to initially charge the monomer, if appropriate in a solvent, bring it to reaction temperature and then add the catalyst I. It is also possible to initially charge the catalyst I, if appropriate in a solvent, and then to add the monomer. The start of polymerization is regarded as being that time at which all reactants are present in the reaction vessel. To prepare copolymers, it is possible to initially charge the monomers, if appropriate in a solvent, and then add the catalyst I. The reaction temperature can also be established before or after the catalyst addition. It is also possible to first initially charge only one of the monomers, if appropriate in a solvent, then to add the catalyst I and, only after a certain time, for example when at least 60%, at least 80% or at least 90% of the monomer has reacted, add the further monomer(s). Alternatively, it is possible to initially charge the catalyst I, if appropriate in a solvent, then add the monomers simultaneously or successively and then establish the desired reaction temperature. The start of polymerization here is regarded as being that time at which the catalyst and at least one of the monomers are present in the reaction vessel.

In addition to the batchwise procedure described here, the polymerization can also be configured as a continuous process. In this case, the feedstocks, i.e. the monomer(s) to be polymerized, if appropriate the solvent and also the catalyst are fed continuously to the polymerization reaction and reaction product is withdrawn continuously, so that more or less steady-state polymerization conditions are established in the reactor. The monomer(s) to be polymerized may be fed as such, diluted with a solvent or as a monomer-containing hydrocarbon stream.

To terminate the reaction, the reaction mixture is preferably deactivated, for example by adding a protic compound, especially by adding water, alcohols such as methanol, ethanol, n-propanol and isopropanol, or mixtures thereof with water, or by adding an aqueous base, for example an aqueous solution of an alkali metal or alkaline earth metal hydroxide such as sodium hydroxide, potassium hydroxide, magnesium hydroxide or calcium hydroxide, of an alkali metal or alkaline earth metal carbonate such as sodium carbonate, potassium carbonate, magnesium carbonate or calcium carbonate, or of an alkali metal or alkaline earth metal hydrogencarbonate such as sodium hydrogencarbonate, potassium hydrogencarbonate, magnesium hydrogencarbonate or calcium hydrogencarbonate.

In a preferred embodiment of the invention, the process according to the invention serves to prepare isobutene homo- or copolymers having a content of terminal vinylidene double bonds (α-double bonds) of at least 50 mol %. More preferably, it serves to prepare highly reactive isobutene homo- or copolymers having a content of terminal vinylidene double bonds (α-double bonds) of at least 60 mol %, preferably of at least 70 mol %, particularly preferably of at least 80 mol %, more preferably of at least 85 mol %, even more preferably of at least 90 mol % and in particular of at least 95 mol %, for example of about 100 mol %.

Preferred isobutene copolymers are copolymers which are formed from monomers comprising isobutene and at least one vinylaromatic compound. These copolymers are preferably highly reactive. Particularly preferred copolymers are isobutene-styrene copolymers.

Accordingly, the process according to the invention serves, in a preferred embodiment, to prepare copolymers which are formed from monomers comprising isobutene and at least one vinylaromatic compound, and especially isobutene-styrene copolymers, having a content of terminal vinylidene double bonds (α-double bonds) of at least 50 mol %. It more preferably serves to prepare highly reactive copolymers which are formed from monomers comprising isobutene and at least one vinylaromatic compound, and especially highly reactive isobutene-styrene copolymers, having a content of terminal vinylidene double bonds (α-double bonds) of at least 60 mol %, preferably of at least 70 mol %, particularly preferably of at least 80 mol %, more preferably of at least 85 mol %, even more preferably of at least 90 mol % and in particular of at least 95 mol %, for example of about 100 mol %.

To prepare such copolymers, isobutene or an isobutenic hydrocarbon cut is copolymerized with at least one vinylaromatic compound, especially with styrene. More preferably, such a monomer mixture comprises from 5 to 95% by weight, more preferably from 30 to 70% by weight of vinylaromatic compound.

In the copolymerization of isobutene or of isobutenic hydrocarbon cuts with at least one vinylaromatic compound, block copolymers are preferably formed even when the comonomers are added simultaneously, in which case the isobutene block generally constitutes the terminal, i.e. the last-formed block.

The polymers prepared by the process according to the invention, especially the isobutene homo- or copolymers and especially the isobutene homopolymers, preferably have a polydispersity (PDI=M_{w}/Mₙ) of preferably from 1.0 to 3.0, particularly preferably from 1.0 to 2.5, more preferably from 1.0 to 2.0, even more preferably from 1.0 to 1.8 and in particular from 1 to 1.5.

The polymers prepared by the process according to the invention, especially the isobutene homo- or copolymers, preferably have a number-average molecular weight Mₙ of from 500 to 1 000 000, particularly preferably from 500 to 250 000, more preferably from 500 to 100 000, even more preferably from 500 to 80 000 and in particular from 500 to 60 000.

Even more preferably, isobutene homopolymers have a number-average molecular weight Mₙ of from 500 to 10 000 and in particular of from 500 to 5000, for example of about 1000 or about 2300.

Copolymers which are formed from monomers comprising isobutene and at least one vinylaromatic compound, and especially isobutene-styrene copolymers, have, especially when they are to be used as thermoplastics, a number-average molecular weight Mₙ of preferably from 500 to 1 000 000, particularly preferably from 10 000 to 1 000 000, more preferably from 50 000 to 1 000 000 and in particular from 50 000 to 500 000.

The data given in the context of the invention for weight-average and number-average molecular weights M_{w} and Mₙ and their quotient PDI (PDI=M_{w}/Mₙ) relate to values which have been determined by means of gel permeation chromatography. The pro-portion of terminal ethylenic double bonds was determined by means of ¹H NMR.

By virtue of the process according to the invention, ethylenically unsaturated monomers which can be polymerized under cationic conditions are successfully polymerized with high conversions within short reaction times even at relatively high polymerization temperatures. When isobutene or isobutenic monomer mixtures are used, highly reactive isobutene homo- or copolymers having a high content of terminal vinylidene double bonds and having a quite narrow molecular weight distribution are obtained.

The process according to the invention can not only be carried out successfully at temperatures of at least 0° C. but additionally allows distinctly shorter reaction times for a comparable conversion and comparable products than the process of EP 1344785. For a isobutene conversion of at least 80%, for example of at least 90%, a polymerization time of at most 2 hours, more preferably of at most one hour, is preferably required.

The present invention further provides a catalyst of the formula I

[M(L)a]^{m+}m(A⁻) (I)

in which
M is Cu, Fe, Mo or Co;
L is a solvent molecule;
A⁻ is a weakly coordinating or noncoordinating anion which is selected from B(Ar)₄⁻, bridged anions of the formula [(Ar)₃B-(μ-Y)—B(Ar)₃]⁻, SbX₆⁻, Sb₂X₁₁⁻, AsX₆⁻, As₂X₁₁⁻, ReX₆⁻, Re₂X₁₁⁻, AlX₄⁻, Al₂X₇⁻, OTeX₅⁻, B(OTeX₅)₄⁻, Nb(OTeX₅)₆⁻, [Zn(OTeX₅)₄]₂⁻, OSeX₅⁻, trifluoromethanesulfonate, perchlorate, carborates and carbon cluster anions, where
   Ar is phenyl which may bear from 1 to 5 substituents which are selected from halogen, C₁-C₄-alkyl and C₁-C₄-haloalkyl;
   Y is a bridging group; and
   X is fluorine or chlorine;
a is an integer from 4 to 6; and
m is 1, 2 or 3.

With regard to suitable and preferred embodiments of the metals M, of the solvent ligands L, of the anion A⁻, of the Ar, Y and X groups and of the indices a and m, reference is made to the above remarks.

More preferably, M is copper, iron or cobalt. In particular, M is copper or iron and especially copper.

More preferably, L is acetonitrile or benzonitrile and especially benzonitrile.

More preferably, A⁻ is B(Ar)₄⁻ or a bridged anion of the formula [(Ar)₃B-(μ-Y)—B(Ar)₃]⁻. The above statements on suitable and preferred Ar and Y groups apply here correspondingly.

a is preferably 6.

m is preferably 2.

The present invention further provides a copolymer formed from monomers comprising isobutene and at least one vinylaromatic compound, which is obtainable by the polymerization process according to the invention. The inventive copolymers preferably have a content of terminal vinylidene double bonds (α-double bonds) of at least 50 mol %. More preferably, the inventive copolymers are highly reactive, i.e. they have a high content of terminal vinylidene double bonds (α-double bonds), for example of at least 60 mol %, preferably of at least 70 mol %, particularly preferably of at least 80 mol %, more preferably at least 85 mol % and in particular of at least 90 mol %, for example of at least 95 mol %, or of about 100 mol %.

The vinylaromatic compound is preferably styrene or 4-methylstyrene and more preferably styrene. Accordingly, particularly preferred copolymers are isobutene-styrene copolymers.

In the inventive copolymer, the total content of copolymerized vinylaromatic compound, based on the total weight of the polymer, is preferably from 5 to 95% by weight and more preferably from 30 to 70% by weight.

The inventive copolymer is preferably a block copolymer, for example a diblock copolymer, triblock copolymer or a higher block copolymer, which comprises at least one polyisobutene block and at least one block of vinylaromatic compounds, the block of vinylaromatic compounds preferably being a styrene block. The polyisobutene block is preferably the terminal, i.e. the last-formed block. The block copolymer is more preferably a diblock copolymer which is formed from a polyisobutene block and a vinylaromatic block, the terminal block preferably being a polyisobutene block. More preferably, the block of vinylaromatic compounds is a styrene block.

The inventive copolymers preferably have a number-average molecular weight Mₙ of from 500 to 1 000 000. Depending on the end use, the inventive copolymers preferably have a higher molecular weight or preferably have a lower molecular weight. When the inventive copolymers are to be used, for example, as thermoplastics, they have a number-average molecular weight Mₙ of preferably from 10 000 to 1 000 000, more preferably from 50 000 to 1 000 000 and in particular from 50 000 to 500 000. When the inventive copolymers are subjected, for example, to functionalization reactions to introduce polar head groups, as described, for example in WO 03/074577 or in the German patent application DE 102005002772.5, they have a number-average molecular weight Mₙ of preferably from 500 to 250 000, particularly preferably from 500 to 100 000, more preferably from 500 to 80 000 and in particular from 1000 to 60 000.

Inventive copolymers which are formed from monomers comprising isobutene and at least one vinylaromatic compound, and especially isobutene-styrene copolymers, can not only be functionalized on the vinylidene-terminated chain ends analogously to highly reactive polyisobutenes in order to optimize them for a certain application, but they additionally have thermoplastic and/or elastic properties. In particular, they or their functionalization products are suitable for use in films, sealant materials, adhesives, adhesion promoters, medical products, for example in the form of certain implants, in particular arterial implants (stents), and compounds.

The functionalization can be effected analogously to derivatization reactions as de-scribed, for example, in WO 03/074577 or in the German patent application DE 102005002772.5, which are hereby fully incorporated by reference.

The invention will now be illustrated by the nonlimiting examples which follow.

### EXAMPLES

### General

All syntheses and reactions were effected under argon atmosphere using a Schlenk technology. Methylene chloride was dried over calcium hydride; n-hexane was dried over sodium/benzophenone and stored over 4 Å molecular sieve; acetonitrile was dried over calcium hydride and stored over 3 Å molecular sieve.

The catalyst used was [Cu(NCCH₃)₆][B(C₆F₅)₄]₂.

### 1.1 Preparation of the Catalyst

A solution of Ag[B(C₆F₅)₄] (1.00 g, 1.27 mmol) in 20 ml of dry acetonitrile was admixed at room temperature under argon with CuCl₂ (0.07 g, 0.64 mmol). The reaction solution was stirred overnight in the dark. The precipitate formed (AgCl) was removed and the filtrate was concentrated under reduced pressure to a volume of about 3 ml and stored at −35° C. The catalyst was obtained in the form of a light green solid in a yield of 0.66 g (73% of theory).

Elemental analysis of C₆₀H₁₈CuB₂F₄₀N₆ (1667.974):

Calculated: C: 43.20%, H: 1.08%, N: 5.04%.

Found: C: 42.98%, H: 1.22%, N: 5.09%.

IR (KBr, cm⁻¹) (selected bands: ν_{CN}): 2340, 2279.

1-19. (canceled)

20. A process for polymerizing ethylenically unsaturated monomers, which comprises polymerizing the ethylenically unsaturated monomers in the presence of a catalyst of the formula I
[M(L)a]^{m+}m(A⁻) (I)
in which
M is Cu, Fe or Co;
L is a solvent molecule which is selected from nitrites, open-chain and cyclic ethers, C₁-C₄-carboxylic acids, esters of C₁-C₄-carboxylic acids with C₁-C₄-alcohols, and carboxamides of C₁-C₄-carboxylic acids with di(C₁-C₄-alkyl)amines;
A⁻ is a weakly coordinating or noncoordinating anion;
a is an integer from 4 to 6; and
m is 1, 2 or 3.

21. The process according to claim 20 for preparing highly reactive isobutene homo- or copolymers.

22. The process according to claim 21 for preparing highly reactive isobutene homo- or copolymers with a content of terminal vinylidene double bonds of at least 80 mol %.

23. The process according to claim 20, wherein M is Cu or Fe.

24. The process according to claim 20, wherein the solvent molecules L in the catalyst of the formula I are the same or different and are selected from nitriles of the formula N≡C—R¹, in which R¹ is C₁-C₈-alkyl or aryl, and open-chain and cyclic ethers.

25. The process according to claim 24, wherein L is a nitrile of the formula N≡C—R¹ in which R¹ is methyl, ethyl or phenyl.

26. The process according to claim 20, wherein A⁻ is selected from BX₄⁻, B(Ar)₄⁻, bridged anions of the formula [(Ar)₃B-(μ-Y)—B(Ar)₃]⁻, SbX₆⁻, Sb₂X₁₁⁻, AsX₆⁻, As₂X₁₁⁻, ReX₆⁻, Re₂X₁₁⁻, AlX₄⁻, Al₂X₇⁻, OTeX₅⁻, B(OTeX₅)₄⁻, Nb(OTeX₅)₆⁻, [Zn(OTeX₅)₄]₂⁻, OSeX₅⁻, trifluoromethanesulfonate, perchlorate, carborates and carbon cluster anions, where
Ar is phenyl which may bear from 1 to 5 substituents which are selected from halogen, C₁-C₄-alkyl and C₁-C₄-haloalkyl;
Y is a bridging group; and
X is fluorine or chlorine.

27. The process according to claim 26, wherein Y is selected from cyclic bridging groups.

28. The process according to claim 26, wherein X is fluorine.

29. The process according to claim 26, wherein A⁻ is B(Ar)₄⁻ or [(Ar)₃B-(μ-Y)—B(Ar)₃]⁻.

30. The process according to claim 20, wherein polymerization is effected at a temperature of at least 0° C.

31. The process according to claim 20 for preparing highly reactive isobutene homo- or copolymers having a number-average molecular weight Mₙ of from 500 to 1 000 000.

32. The process according to claim 21, wherein the highly reactive isobutene homo- or copolymers have a polydispersity of at most 2.

33. The process according to claim 20 for preparing copolymers which are formed from monomers comprising isobutene and at least one vinylaromatic compound.

34. A catalyst of the formula I
[M(L)a]^{m+}m(A⁻) (I)
in which
M is Cu, Fe or Co;
L is a solvent molecule which is selected from nitriles, open-chain and cyclic ethers, C₁-C₄-carboxylic acids, esters of C₁-C₄-carboxylic acids with C₁-C₄-alcohols, and carboxamides of C₁-C₄-carboxylic acids with di(C₁-C₄-alkyl)amines;
A⁻ is a weakly coordinating or noncoordinating anion which is selected from B(Ar)₄⁻, bridged anions of the formula [(Ar)₃B-(μ-Y)—B(Ar)₃]⁻, SbX₆⁻, Sb₂X₁₁⁻, AsX₆⁻, As₂X₁₁⁻, ReX₆⁻, Re₂X₁₁⁻, AlX₄⁻, Al₂X₇⁻, OTeX₅⁻, B(OTeX₅)₄⁻, Nb(OTeX₅)₆⁻, [Zn(OTeX₅)₄]₂⁻, OSeX₅⁻, trifluoromethanesulfonate, perchlorate, carborates and carbon cluster anions, where
Ar is phenyl which may bear from 1 to 5 substituents which are selected from halogen, C₁-C₄-alkyl and C₁-C₄-haloalkyl;
Y is a bridging group; and
X is fluorine or chlorine;
a is an integer from 4 to 6; and
m is 1, 2 or 3.

35. The catalyst according to claim 34, in which M is Cu or Fe.

36. The catalyst according to claim 34, in which L is benzonitrile.

37. The catalyst according to claim 34, in which A⁻ is B(Ar)₄⁻or [(Ar)₃B-(μ-Y)—B(Ar)₃]⁻.

38. A copolymer formed from monomers comprising isobutene and at least one vinylaromatic compound, obtainable by a process according to claim 20.
